(19) United States
(12) Patent Application Publication
(10) Pub. No.: US 2025/0272320 A1
(43) Pub. Date: Aug. 28, 2025

(54) QUESTION RESPONSE APPARATUS, METHOD, AND STORAGE MEDIUM

(71) Applicants: KABUSHIKI KAISHA TOSHIBA, Tokyo (JP); Toshiba Digital Solutions Corporation, Saiwai-ku Kawasaki-shi (JP)

(72) Inventors: Kenichi DONIWA, Asaka Saitama (JP); Hidetaka OHIRA, Tokyo (JP); Takeshi SHIMIZU, Yokohama Kanagawa (JP)

(73) Assignees: KABUSHIKI KAISHA TOSHIBA, Tokyo (JP); Toshiba Digital Solutions Corporation, Saiwai-ku Kawasaki-shi (JP)

(21) Appl. No.: 19/056,511

(22) Filed: Feb. 18, 2025

(30) Foreign Application Priority Data
Feb. 22, 2024 (JP) 2024-025734

(51) Int. Cl. G06F 16/3329; G06F 16/332

(52) U.S. Cl. CPC G06F 16/33295; G06F 16/3325

(57) ABSTRACT

A question response apparatus includes processing circuitry. The processing circuitry is configured to acquire a question input by a user generate a query based on the question search a search result related to the query from a plurality of information sources determine consistency of the search result generate an integration prompt in which a search result determined to be consistent and the question are integrated and generate an answer to the question by inputting the integration prompt into a large language model.

### CROSS-REFERENCE TO RELATED APPLICATION

This application is based upon and claims the benefit of priority from Japanese Patent Application No. 2024-025734, filed Feb. 22, 2024, the entire contents of which are incorporated herein by reference.

### FIELD

Embodiments described herein relate generally to a question response apparatus, a method, and a storage medium.

### BACKGROUND

In recent years, a large language model (LLM) can be learned by a large amount of text data, and the large language model can answer a question in a natural language. In a system using such a large language model, information related to an input question is searched using a knowledge base or database constructed in advance, and the question and the searched information are input into the large language model to generate an appropriate answer. In such a system, an inference is made as to what action should be taken to answer a question, information related to the question is acquired by executing an appropriate action, and an appropriate answer is generated by inputting the question and the acquired information into the large language model.

The large language model can answer a question about learned knowledge, but cannot answer a question about unlearned knowledge. For this reason, a phenomenon called hallucination may occur in which the large language model generates an answer contrary to the fact.

There is a method of combining search results from a plurality of information sources in order to accurately answer about knowledge that has not been learned. For example, there is a case where it is desired to benchmark image anomaly detection technology developed by the company with technology of another company. In this case, in the internal information search, detailed information on the company's image anomaly detection technology can be acquired, but information on other company's technology cannot be acquired. In addition, it is not appropriate to answer that there is no similar technology of other companies from the search result of the internal information, and it is necessary to search also information on the Internet and generate an answer. On the other hand, in the Internet search, it is not possible to acquire information, which is not published to the outside of the company, on the company's image anomaly detection technology, but it is possible to acquire information on the similar technology of other companies. It is necessary to generate a baseline answer by combining a search result of the company's image anomaly detection technology which can be acquired by the internal information search and a search result of the similar technology of other companies which can be acquired by the Internet search.

However, in a case of using the search results from a plurality of information sources to inquire a large language model for a question, simply combining search results from the information sources may result in poor answer quality. This is because an appropriate answer cannot be generated in a case where the search results do not have consistency. Therefore, it is required to improve the answer accuracy of the large language model using information from the plurality of information sources.

### BRIEF DESCRIPTION OF DRAWINGS

FIG. 1 is a diagram showing an example of a configuration of a question response system according to a first embodiment.

FIG. 2 is a diagram showing an example of a configuration of a question response apparatus according to the first embodiment.

FIG. 3 is a flowchart showing a processing procedure of question response processing according to the first embodiment.

FIG. 4 is a diagram showing a flow of data in the question response processing according to the first embodiment.

FIG. 5 is a flowchart showing a processing procedure of consistency determination processing according to the first embodiment.

FIG. 6 is a flowchart showing the processing procedure of the consistency determination processing according to a modification.

FIG. 7 is a diagram for explaining a consistency determination method according to the modification.

FIG. 8 is a diagram showing an example of a configuration of the question response apparatus according to a second embodiment.

FIG. 9 is a flowchart showing the processing procedure of the question response processing according to the second embodiment.

FIG. 10 is a diagram showing a flow of data in the question response processing according to the second embodiment.

FIG. 11 is a diagram showing a flow of data in the question response processing according to a third embodiment.

### DETAILED DESCRIPTION

According to one embodiment, a question response apparatus includes processing circuitry. The processing circuitry is configured to acquire a question input by a user generate a query based on the question search a search result related to the query from a plurality of information sources determine consistency of the search result generate an integration prompt in which a search result determined to be consistent and the question are integrated and generate an answer to the question by inputting the integration prompt into a large language model.

Hereinafter, embodiments of a question response apparatus, a method, and a program will be described in detail with reference to the drawings. In the following description, components having substantially the same functions and configurations are denoted by the same reference signs, and redundant description will be made only if necessary.

### First Embodiment

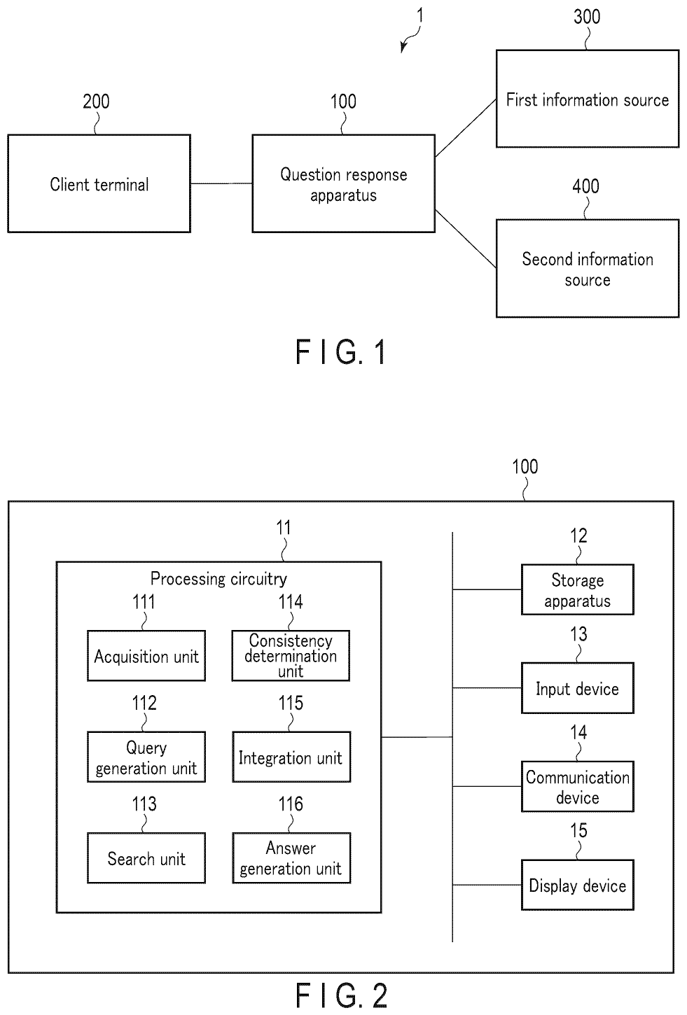

FIG. 1 is a diagram showing a configuration of a question response system 1 including a question response apparatus 100 according to a first embodiment. The question response system 1 is an interactive computer network system using a large language model that searches an information source for information that matches a user's question and presents a search result to the user. As shown in FIG. 1, the question response system 1 includes a question response apparatus 100, a client terminal 200, a first information source 300, and a second information source 400.

The question response apparatus 100 is connected to the client terminal 200, the first information source 300, and the second information source 400 via a network or the like. The network is, for example, a local area network (LAN). Note that, the connection to the network may be a wired connection or a wireless connection. In addition, the network is not limited to the LAN, and may be the Internet, a public communication line, or the like.

The client terminal 200 is a computer used by the user of the question response system 1. The client terminal 200 includes a processor, an input device, a display device, and a communication device as hardware, and functions as a user interface of the question response system 1. For example, the client terminal 200 receives an input of a question by the user via the input device. The question is, for example, text data, and can also be referred to as an inquiry from the user. The question may be input as a natural sentence such as a question sentence, or may be input as a word such as a search word. The client terminal 200 transmits the question input by the user to the question response apparatus 100.

In addition, the client terminal 200 receives an answer to the question from the question response apparatus 100 and displays the received answer on the display device. The answer is text data, and may also be referred to as a response to an inquiry from the user.

The first information source 300 and the second information source 400 are information sources capable of searching data to be searched. As the first information source 300 and the second information source 400, the information sources having different types and including different information can be used. Each of the first information source 300 and the second information source 400 is, for example, an internal database, a homepage of an academic society, a paper database, the Internet, a social networking service (SNS), or the like. In a case where the search result of the first information source 300 and the search result of the second information source 400 are simply combined, hallucination may occur.

In addition, an information source with high reliability may be used as the first information source 300, and an information source with high searchability may be used as the second information source 400. As the information source with high reliability, for example, an internal database, a homepage of an academic society, a paper database, or the like can be used. Note that, the Internet information may be used as the information source with high reliability. The information source with high searchability is, for example, an information source with a large amount of information. As the information source with high searchability, for example, the Internet, the social networking service (SNS), or the like can be used. The information sources with high searchability may have low reliability.

The question response apparatus 100 functions as a server of the question response system 1. The question response apparatus 100 answers a question from the user by combining the information acquired from the first information source 300 and the second information source 400. Specifically, the question response apparatus 100 receives a question input by the user from the client terminal 200, searches the first information source 300 and the second information source 400 for information related to the question based on the received question, generates an answer to the question using the search result, and transmits the generated answer to the client terminal 200. The question response apparatus 100 may be referred to as a question response processing apparatus. In addition, the question response system 1 including the question response apparatus 100 may be called a question response processing system.

FIG. 2 is a diagram showing a configuration of the question response apparatus 100. The question response apparatus 100 is a computer including processing circuitry 11, a storage apparatus 12, an input device 13, a communication device 14, and a display device 15. The data communication among the processing circuitry 11, the storage apparatus 12, the input device 13, the communication device 14, and the display device 15 is performed via a bus. The input device 13 and the display device 15 may not be provided.

The processing circuitry 11 includes a processor such as a central processing unit (CPU) and a memory such as a random access memory (RAM). The processing circuitry 11 includes an acquisition unit 111, a query generation unit 112, a search unit 113, a consistency determination unit 114, an integration unit 115, and an answer generation unit 116. The processing circuitry 11 realizes an acquisition function, a query generation function, a search function, a consistency determination function, an integration function, and an answer generation function by the above units by executing a program.

The storage apparatus 12 includes a read only memory (ROM), a hard disk drive (HDD), a solid state drive (SSD), an integrated circuit storage apparatus, and the like. The storage apparatus 12 stores a program and the like.

The program is stored in a non-transitory computer-readable recording medium such as the storage apparatus 12. The program may be implemented as a single program that describes all the functions of the above units, or may be implemented as a plurality of modules divided into several functional units. In addition, each of the above units may be implemented by an integrated circuit such as an application specific integrated circuit (ASIC). In this case, each of the above units may be implemented by a single integrated circuit, or may be individually mounted by a plurality of integrated circuits. In addition, each of the above units may be implemented by a single apparatus or may be mounted in a distributed manner by a plurality of apparatuses. For example, some or all of the above units may be implemented by the client terminal 200.

The input device 13 inputs various commands from an operator. As the input device 13, a keyboard, a mouse, various switches, a touch pad, a touch panel display, and the like can be used. An output signal from the input device 13 is supplied to the processing circuitry 11.

The communication device 14 is an interface for performing data communication with an external apparatus connected to the question response apparatus 100 via a network. For example, the communication device 14 performs data communication with the first information source 300 and the second information source 400.

The display device 15 displays various types of information. As the display device 15, a cathode-ray tube (CRT) display, a liquid crystal display, an organic electro luminescence (EL) display, a light-emitting diode (LED) display, a plasma display, or any other display known in the art can be appropriately used. In addition, the display device 15 may be a projector.

Next, each function executed by each unit of the processing circuitry 11 will be described in detail.

The acquisition unit 111 acquires the question input from the user from the client terminal 200.

The query generation unit 112 generates a query for searching for information related to the acquired question based on the acquired question. The query is used to search from the first information source 300 and the second information source 400. The query is a keyword extracted from the question or an embedded expression of the question. The query generation unit 112 generates a query, for example, by inquiring the large language model about the keyword of the question. For example, the query generation unit 112 may generate an embedded expression as a query used for searching the first information source 300, and may generate a keyword as a query used for searching the second information source 400.

In this manner, the query generation unit 112 may generate a query common to a plurality of information sources, or may generate a different query for each information source. The query generation unit 112 of the present embodiment is an example of a first query generation unit and a second query generation unit.

The search unit 113 executes a search using a query for the information sources to search each of the plurality of information sources for the information related to the query. At this time, the search unit 113 searches each of the first information source 300 and the second information source 400 for the information related to the query. For example, in a case where the query is a keyword, the search unit 113 searches the information source for text data or document data including the keyword. In addition, in a case where the query is an embedded expression, the search unit 113 generates an embedded expression of each piece of information included in the information source, and searches for information whose embedded expression is similar to the query. Hereinafter, a result searched from the first information source 300 is referred to as a first search result, and a result searched from the second information source 400 is referred to as a second search result.

The consistency determination unit 114 confirms the consistency of a plurality of search results searched from different information sources. Specifically, the consistency determination unit 114 determines the consistency between the first search result searched from the first information source 300 and the second search result searched from the second information source 400.

The consistency determination unit 114 may be referred to as a consistency check unit.

For example, the consistency determination unit 114 determines the consistency of the search results by using a consistency score between the search results. The consistency score is an index indicating the degree of consistency between the first search result and the second search result. The consistency score may be referred to as a consistency degree. As the consistency score, for example, the cosine similarity between the first search result and the second search result can be used. In this case, the consistency determination unit 114 determines that the search results are consistent in a case where the cosine similarity is equal to or greater than a threshold, and determines that the search results are not consistent in a case where the cosine similarity is less than the threshold.

In addition, the consistency score may be calculated using the large language model or a machine learning model. In this case, for example, the first search result, the second search result, and the sentence “calculate a consistency score indicating the consistency of the two pieces of information. However, the consistency score is a value from 0.0 to 1.0, and the closer to 1.0, the higher the consistency.” are input into the large language model, and a value output from the large language model is used as the consistency score.

In addition, the consistency determination unit 114 may determine the consistency using the large language model or the machine learning model. In this case, the consistency determination unit 114 inputs a question for inquiring whether the search results are consistent together with the first search result and the second search result into the large language model, and determines the consistency based on the output of the large language model.

The integration unit 115 integrates the question and the search result for which the consistency is confirmed to generate an integration prompt. At this time, the integration unit 115 generates the integration prompt in which a combination of a question, a first search result determined to have consistency, and a second search result determined to have consistency is integrated. The integration prompt is used as a question sentence input into the large language model by the answer generation unit 116.

The answer generation unit 116 generates an answer to the user's question by inputting the integration prompt into the large language model. For example, the answer generation unit 116 inquires the large language model about the integration prompt and generates an answer. The generated answer is transmitted to the client terminal 200 and displayed on a display device of the client terminal 200.

### Question Response Processing

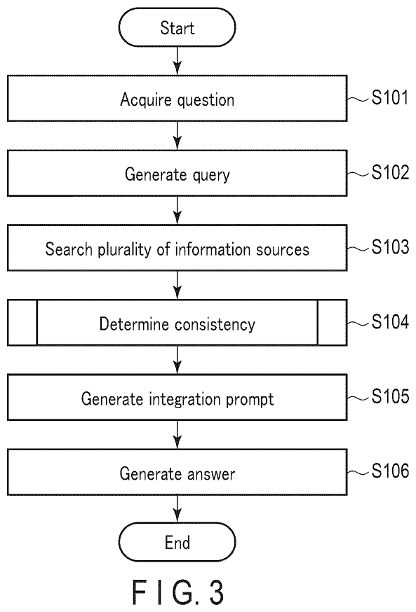

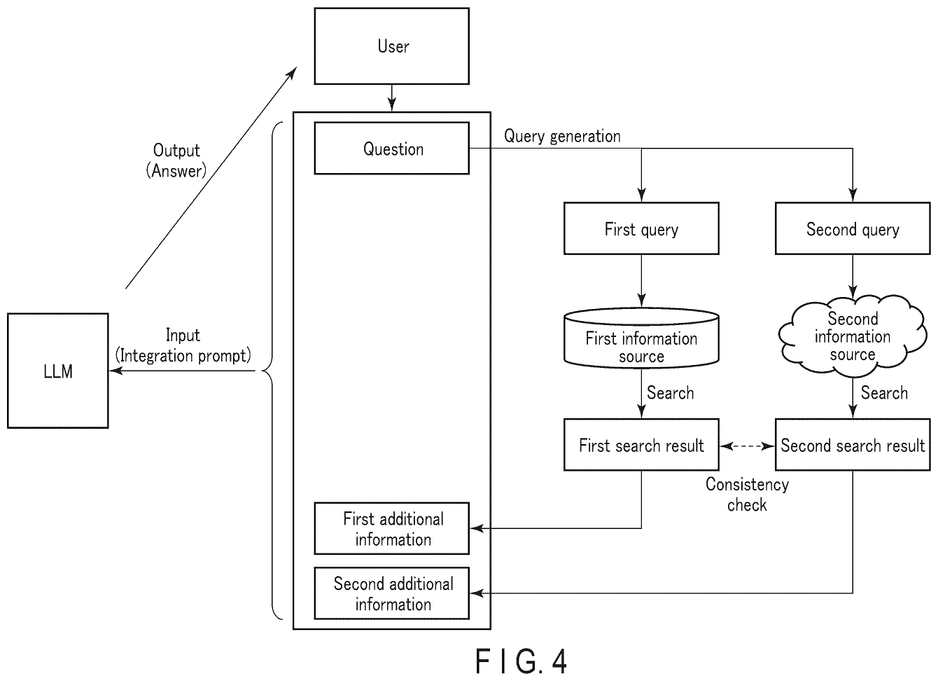

Next, the operation of the question response processing executed by the question response apparatus 100 will be described. FIG. 3 is a flowchart showing an example of a procedure of the question response processing. In addition, FIG. 4 is a diagram showing an example of a flow of data in the question response processing. The question response processing is processing of generating an answer to the user's question input through the client terminal 200. The processing circuitry 11 starts the question response processing based on reception of the question input by the user through the client terminal 200.

Note that, the processing procedure in each processing described below is merely an example, and each processing can be appropriately changed as much as possible. In addition, in the processing procedure described below, it is possible to appropriately omit, replace, and add steps according to the embodiment.

### Step S101

In the question response processing, first, the acquisition unit 111 acquires the question received from the client terminal 200 as a user's question.

### Step S102

Next, the query generation unit 112 generates a query using the question acquired in step S101. At this time, the query generation unit 112 generates a first query used for searching the first information source and a second query used for searching the second information source. The first query and the second query may be the same or different.

### Step S103

Next, the search unit 113 searches the plurality of information sources for the information related to the question using the query generated in step S102. At this time, the search unit 113 searches the first information source 300 for the information related to the first query and acquires the searched information as the first search result. In addition, the search unit 113 searches the second information source 400 for the information related to the second query and acquires the searched information as the second search result. Here, it is assumed that information is searched one by one from each of the first information source 300 and the second information source 400. The first search result includes a piece of relevant information for the first query in the first information source 300, and the second search result includes a piece of relevant information for the second query in the second information source 400.

### Step S104

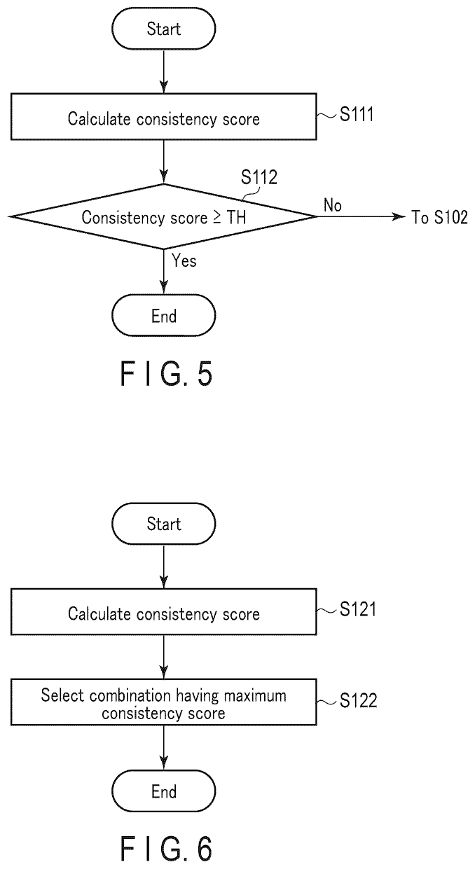

Next, the consistency determination unit 114 executes consistency determination processing. The consistency determination processing is processing of determining the consistency between the first search result and the second search result. FIG. 5 is a flowchart showing an example of the procedure of the consistency determination processing of the present embodiment.

### Step S111

In the consistency determination processing, first, the consistency determination unit 114 calculates the consistency score between the first search result and the second search result. For example, the consistency determination unit 114 obtains an embedded expression of the first search result and an embedded expression of the second search result by using sBERT and calculates the cosine similarity between the embedded expression of the first search result and the embedded expression of the second search result as the consistency score.

### Step S112

Next, the consistency determination unit 114 determines whether the cosine similarity calculated as the consistency score is equal to or greater than a threshold TH. The threshold TH is set in advance and stored in the storage apparatus 12. If the cosine similarity is smaller than the threshold TH (No in step S112), the processing returns to step S102, and the processing of step S102, step S103, and step S111 is executed again. At this time, a query generation method in step S102 and a search condition in step S103 are changed. For example, in a case where the information having the highest relevance to the second query among the second information sources 400 is used as the second search result, the second search result is updated to the information having the second highest relevance to the second query among the second information sources 400. Then, in step S111, the cosine similarity between the first search result and the updated second search result is recalculated, and in step S112, the recalculated cosine similarity is compared with the threshold TH. The processing circuitry 11 repeatedly executes the search in which the search condition was changed and the consistency determination until the cosine similarity becomes equal to or greater than the threshold TH. Then, in a case where the cosine similarity is equal to or greater than the threshold TH (Yes in step S112), the consistency determination unit 114 determines that the combination of the first search result and the second search result in which the cosine similarity is equal to or greater than the threshold TH is a search result having consistency.

### Step S105

The integration unit 115 integrates the question and the search result in which the consistency is confirmed to generate the integration prompt. At this time, the first search result determined to have consistency is used as the first additional information, and the second search result determined to have consistency is used as the second additional information. The integration unit 115 inputs the question input by the user and a combination of the first search result and the second search result determined to have consistency into the large language model, thereby causing the large language model to generate the integration prompt.

As an example, a case will be described where the first information source 300 is an internal database of the company A, the second information source 400 is the Internet, and the question “Please benchmark the image anomaly detection technology developed by the company A and the technology of another company.” is input. It is assumed that a sentence “The image anomaly detection technology of the company A automatically generates training data by AI using a generative adversarial network technology, thereby realizing highly accurate inference even with a small number of training data.” is searched from the internal database as the first search result, and a sentence “The image anomaly detection technology of the company B detects an anomaly by calculating a reconfiguration error using an auto encoder.” is searched from the Internet as the second search result. In this case, the integration unit 115 integrates the above question and the search results and generates the integrated sentence “Generate a question based on the following information of the first search result and the second search result. The question is “Please benchmark the image anomaly detection technology developed by the company A and the technology of other companies.”. The first search result is “The image anomaly detection technology of the company A automatically generates training data by AI using the generative adversarial network technology, thereby realizing highly accurate inference even with a small number of training data.”. The second search result is “The image anomaly detection technology of the company B detects an anomaly by calculating a reconfiguration error using an auto encoder.”.

### Step S106

The answer generation unit 116 generates an answer by using the generated integration prompt and the large language model. At this time, the answer generation unit 116 makes the large language model output the answer to the integration prompt by inquiring the large language model about the integration prompt generated in step S105.

Thereafter, the processing circuitry 11 outputs the answer acquired from the large language model to the client terminal 200 as an answer to the question input by the user.

Hereinafter, effects of the question response apparatus 100 according to the present embodiment will be described.

The question response apparatus 100 according to the present embodiment includes the acquisition unit 111, the query generation unit 112, the search unit 113, the consistency determination unit 114, the integration unit 115, and the answer generation unit 116. The acquisition unit 111 acquires a question input by the user. The query generation unit 112 generates a query based on the question. The search unit 113 searches search results related to the query from a plurality of information sources.

The consistency determination unit 114 determines consistency of the search results. The integration unit 115 generates an integration prompt in which the search results determined to have the consistency and the question are integrated. The answer generation unit 116 generates an answer to the question by inputting the integration prompt into the large language model.

Conventionally, in case of using search results from the plurality of information sources to inquire the large language model about the question, simply combining the search results from the plurality of information sources may result in poor answer quality. This is because an appropriate answer cannot be generated in a case where the search results do not have consistency. In response to such a problem, the question response apparatus 100 according to the present embodiment can improve the answer quality of the large language model by confirming the consistency of the search results from the plurality of information sources and integrating only the consistent search results into the prompt.

The query is, for example, a keyword extracted from the question. In this case, the search unit 113 searches the information source for information including the keyword. For example, the search unit 113 extracts a keyword by inquiring the large language model about the keyword in the question. In addition, the query may also be an embedded expression of the question. In this case, the search unit 113 converts the information of each information source into an embedded expression, and searches the information source for the information similar to the embedded expression of the question.

For example, the consistency determination unit 114 determines the consistency of the search results by calculating a consistency score between the search results and determining whether the calculated consistency score is a threshold or more. The consistency score is, for example, the cosine similarity between embedded expressions.

For example, in a case where it is determined that the search results do not have consistency, the generation of query by the query generation unit 112 and the search by the search unit 113 are executed again. At this time, the query generation condition and the search condition are changed, and the search results are updated. Then, the generation of query and the search are repeatedly executed until it is determined that the search results have consistency. Note that, the consistency of the search results may be determined by inquiring the large language model whether or not the search results have consistency.

As an application of the present embodiment, a case will be described in which an answer is generated by combining internal information and information of the Internet with respect to a question for inquiring information on laws and regulations called an export trade control order. In this example, the internal information and the Internet are used as the plurality of information sources. In a case where the export trade control order is revised but the in-house rule of the export trade control is not reviewed, the in-house rule based on the export trade control order before the revision is acquired as a search result of the internal information, and the export trade control order after the revision is acquired as a search result of the Internet.

If the answer is generated by the large language model by simply combining the two pieces of information, the information before the revision and the information after the revision will be combined, and there is a risk that the answer including the hallucination will be generated.

In contrast to the above application, according to the question response apparatus 100 of the present embodiment, it is possible to improve the answer quality by confirming consistency between the acquired search results and generating an answer not using inconsistent information, but using only consistent information.

As another application, a case will be described in which an answer is generated by combining internal information and information of the Internet with respect to a question for inquiring about the personal history of an employee A of the company. In this example, for example, the internal information corresponds to the first information source 300, and the Internet corresponds to the second information source 400. The internal information is a more reliable information source than the Internet. The Internet is an information source that is less reliable than the internal information but has a larger amount of information than the internal information.

In the internal information search, it is possible to acquire a technical document and the like reported by the employee A in his/her department or the like, but it is not possible to acquire a paper and the like presented by the employee A in his/her university days. Therefore, it is not appropriate to determine that there is a technical document reported by the employee A but there is no paper presented by the employee A in his/her university days only from the search result of the internal information. Therefore, it is necessary to search information of the Internet to generate an answer. On the other hand, in the Internet search, it is not possible to acquire a technical document and the like internally reported by the employee A, but it is possible to acquire a paper and the like presented by the employee A in his/her university days. However, in a case where two persons whose first and last names are the same as the employee A are searched, and information on a person other than the employee A is used for the answer, the degradation of the answer quality will be caused.

In contrast to the above application, according to the question response apparatus 100 according to the present embodiment, it is possible to confirm the consistency between the age of the person searched from the Internet and the age of the employee A searched from the internal information with high reliability, determine the information on the person of the same age as the search result having the consistency with the internal information, and determine the information on the person of a different age as the search result having no consistency with the internal information. Then, by using the information such as a paper presented by a person of the same age as the employee A and information such as the technical document reported by the employee A internally as consistent search results, it is possible to give an answer with a high quality.

Note that, in a case where no search result having consistency is found, the integration prompt may be generated by using only a search result from an information source with high reliability among search results searched from a plurality of information sources. For example, if no combination of the search results with a high similarity score is found, the search results searched from less reliable information sources may not be used, and only search results searched from more reliable information sources and the question may be used to generate an integration prompt.

As an application in this case, a case will be described in which a document represented by the employee A is searched from the homepage of the academic society (hereinafter, referred to as an academic society homepage) and the SNS. In this example, the academic society homepage corresponds to the first information source 300, and the SNS corresponds to the second information source 400. The academic society homepage is a more reliable information source than the SNS. The SNS is an information source that is less reliable than the academic society homepage but has a larger amount of information than the academic society homepage.

For example, it is assumed that only a paper 1 of “anomaly detection by random forest” is searched from the academic society homepage, only a paper 2 of “anomaly detection by machine learning” is searched from the SNS, and it is determined that there is no consistency between the first search result and the second search result. In this case, since the reliability of the academic society homepage is higher than that of the SNS, the answer quality can be enhanced by generating the integration prompt by using only the paper 1 and the question searched from the academic society homepage without using the paper 2 searched from the SNS.

As another application, a case will be described where a document having the best performance related to a certain disease is searched using PubMed (registered trademark) and the Internet. The PubMed is a medical paper database available on the Internet. In this example, the PubMed corresponds to the first information source 300, and the Internet corresponds to the second information source 400. In a case where the paper A is found in the PubMed and the explanatory material of the paper A is found in the Internet, because the two search results are consistent, the integration prompt is generated using the paper A and the explanatory material thereof as the consistent search result, and the answer is generated. On the other hand, in a case where the paper A is searched as the search result of the PubMed, an Internet article B is searched as the search result of the Internet, and it is determined that the two search results are not consistent, the answer quality can be enhanced by generating the integration prompt using the paper A searched from the highly reliable PubMed and the question without using the Internet article B.

In addition, the consistency of the search results may be determined in consideration of the subsidiarity of the search results. For example, even in a case where the consistency scores between the first search result and the second search result are low, it is preferable to determine that the subsidiarity between the first search result and the second search result is high and determine that the first search result and the second search result have consistency in a case where the both similarities to the content of the question are high.

For example, as an application, a case of searching the internal database and the Internet for the educational background, the personal history, and the hobby of the employee A will be described. For example, the internal database corresponds to the first information source 300, and the Internet corresponds to the second information source 400. In a case where the educational background and the personal history of the employee A are searched from the internal database and the hobby of the employee A is searched from the Internet, the similarity between the educational background and the personal history searched from the internal database and the hobby searched from the Internet is low. However, since each search result includes content matching the question content, the similarity of the search result to the question increases. Therefore, it is preferable to determine that the subsidiarity between the search results is high and determine that the search results have consistency. In this case, by complementing the information of the internal database and the information of the Internet, it is possible to acquire information on the educational background, the personal history, and the hobby of the employee A.

In addition, in the present embodiment, the case has been described where the integration prompt is generated by combining the search results of two information sources, but the search results acquired from three or more information sources may be combined. For example, in addition to the first information source 300 such as the internal database and the second information source 400 such as the Internet, the large language model may be used as a third information source. In this case, it is possible to further improve the answer quality by generating the answer using only the information that is consistent in all the three information sources.

### First Modification

In the above embodiment, the generation of the query and the search are repeatedly executed until the search results are determined to be consistent. In the present modification, the consistency determination unit 114 extracts a combination of the search results having the maximum consistency score, and determines the combination of the search results as the search results having consistency.

### Consistency Determination Processing

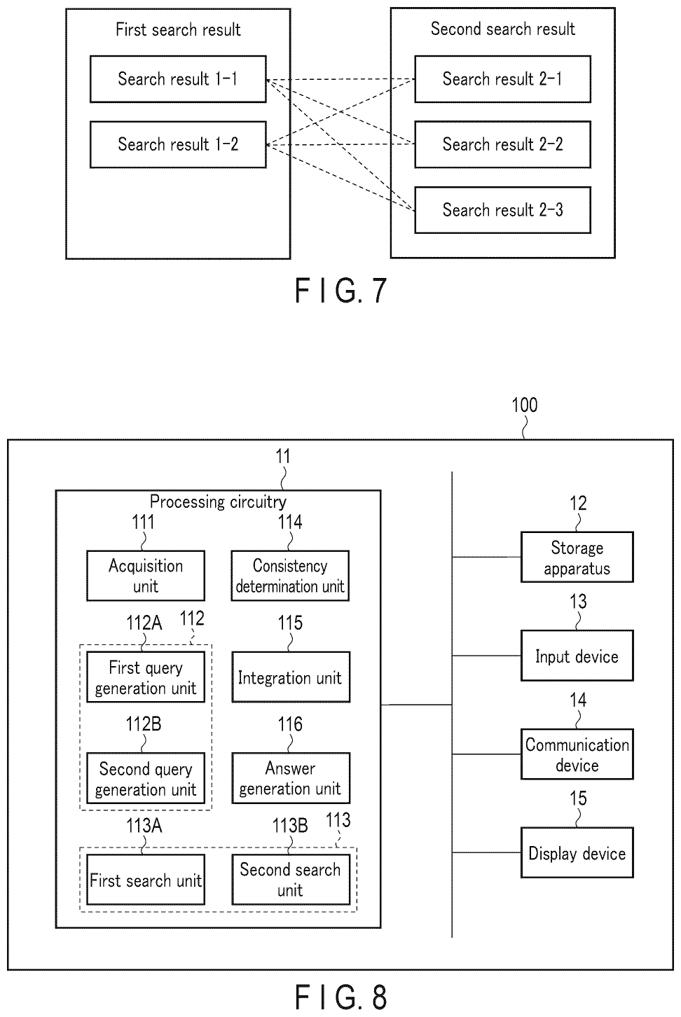

FIG. 6 is a flowchart showing an example of a procedure of consistency determination processing according to the present modification. FIG. 7 is a diagram showing an example of the first search result and the second search result in the present modification. Here, in the processing of step S103, it is assumed that two pieces of information of the search result 1-1 and the search result 1-2 are searched as the first search result, and three pieces of information of the search result 2-1, the search result 2-2, and the search result 2-3 are searched as the second search result.

### Step S121

In the consistency determination processing, first, the consistency determination unit 114 calculates the consistency score between the first search result and the second search result. The consistency determination unit 114 obtains an embedded expression of the first search result and an embedded expression of the second search result by using sBERT, and calculates the cosine similarity between the embedded expression of the first search result and the embedded expression of the second search result. At this time, the consistency determination unit 114 calculates the cosine similarities for all combinations of the search results included in the first search result and the search results included in the second search result. In the example of FIG. 7, six cosine similarities of the cosine similarity between the search result 1-1 and the search result 2-1, the cosine similarity between the search result 1-1 and the search result 2-2, the cosine similarity between the search result 1-1 and the search result 2-3, the cosine similarity between the search result 1-2 and the search result 2-1, the cosine similarity between the search result 1-2 and the search result 2-2, and the cosine similarity between the search result 1-2 and the search result 2-3 are calculated as the consistency scores.

### Step S122

Next, the consistency determination unit 114 determines that the combination having the maximum consistency score is the search results having the consistency. Here, the combination having the largest cosine similarity among the six combinations is selected as the search results having consistency.

According to the present modification, even in a case where a plurality of pieces of information is searched from each of a plurality of information sources, it is possible to generate an integration prompt by using only consistent search results and improve the answer quality of the large language model.

### Second Embodiment

A second embodiment will be described. The present embodiment is obtained by modifying the configuration of the first embodiment as follows. Description of configurations, operations, and effects similar to those of the first embodiment will be omitted.

FIG. 8 is a diagram showing a configuration example of a question response apparatus 100 according to the present embodiment. As shown in FIG. 8, a query generation unit 112 includes a first query generation unit 112A that generates a first query based on a question, and a second query generation unit 112B that generates a second query based on a question. In the present embodiment, the second query generation unit 112B generates the second query using a first search result. As the second query, for example, the embedded expression of the first search result or a keyword extracted from the first search result can be used.

In addition, a search unit 113 includes a first search unit 113A that searches the first search result related to the first query from a first information source 300, and a second search unit 113B that searches the second search result related to the second query from a second information source 400.

A consistency determination unit 114 determines consistency between the first search result and the second search result. An integration unit 115 generates an integration prompt in which a question, the first search result determined to have consistency, and the second search result determined to have consistency are integrated. An answer generation unit 116 generates an answer to the question using the integration prompt and the large language model. Since a method of determining consistency, a method of generating an integration prompt, and a method of generating an answer by using the integration prompt are similar to those in the first embodiment, the descriptions thereof are omitted.

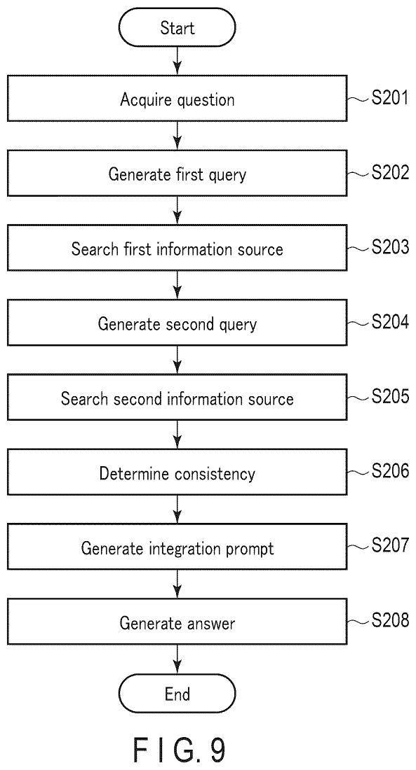

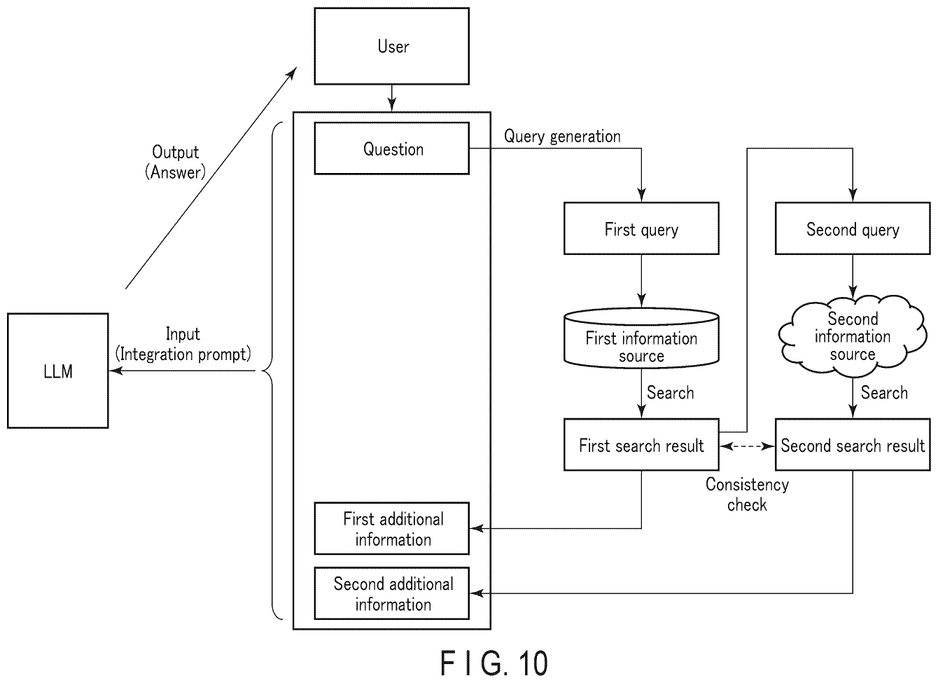

Next, an operation of the question response processing executed by the question response apparatus 100 according to the present embodiment will be described. FIG. 9 is a flowchart showing an example of a procedure of the question response processing. In addition, FIG. 10 is a diagram showing an example of a flow of data in the question response processing.

In the question response processing of the present embodiment, the first query generation unit 112A generates the first query used for searching the first information source 300 using the question acquired in the processing of step S201 (step S202). For example, the first query generation unit 112A inquires the large language model about the keyword of the question to acquire the extracted keyword as the first query. Thereafter, the first search unit 113A executes a search of the first information source 300 using the first query to acquire the first search result related to the question (step S203). For example, by searching the first information source 300 for the information including the first query, the first search unit 113A searches the first information source 300 for the information related to the question.

Next, the second query generation unit 112B generates the second query used for searching the second information source 400, using the first search result generated in the processing of step S203 (step S204). For example, the second query generation unit 112B inquires the large language model about the keyword related to the information acquired as the first search result to acquire the extracted keyword as the second query. Thereafter, the second search unit 113B searches the second information source 400 using the second query to acquire the second search result related to the first search result (step S205). Since the first search result is the information related to the question searched using the question, the second search result related to the first search result is also the information related to the question.

Next, the consistency determination unit 114 determines the consistency between the first search result acquired in the processing of step S203 and the second search result acquired in the processing of step S205 (step S206). The integration unit 115 integrates the combination of the first search result and the second search result determined to have the consistency and the question to generate the integration prompt (step S207). Then, the answer generation unit 116 generates an answer to the question by inquiring the large language model using the generated integration prompt (step S208).

The question response apparatus 100 of the present embodiment can generate the second query with high reliability by generating the second query using the search result of the first information source 300 with high reliability. Then, by searching the second information source 400 using the second query, highly reliable information can be searched from the second information source 400. In addition, by generating an answer to the question by using the integration prompt generated by using the highly reliable search result, the answer quality can be further improved.

Note that, also in the present embodiment, similarly to the first embodiment and the modification, it may be determined that the combination of the search results having the maximum consistency score is consistent, only search results from the information source having high reliability may be used in a case where no combination of the search results having a high similarity score is found, the consistency of search results may be determined in consideration of subsidiarity of the search results, or the search results acquired from three or more information sources may be combined.

### Third Embodiment

A third embodiment will be described. The present embodiment is obtained by modifying the configuration of the second embodiment as follows. Description of configurations, operations, and effects similar to those of the second embodiment will be omitted.

In the present embodiment, a second query generation unit 112B generates the second query using both the question and the first search result searched from a first information source 300 using the question. As the second query, for example, an embedded expression generated using the question and the first search result or the keyword extracted from the question and the first search result can be used.

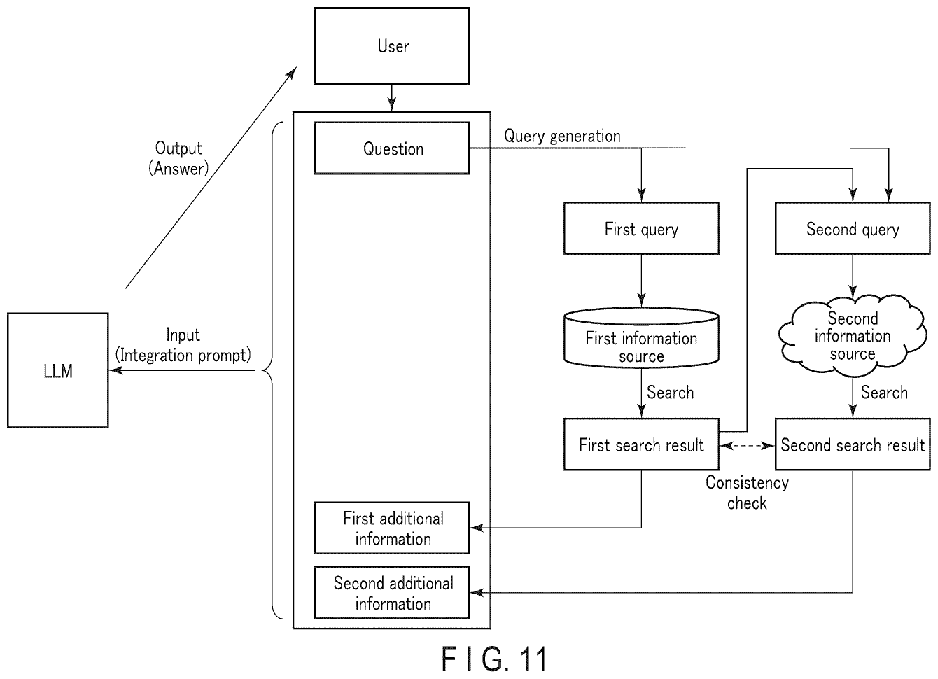

FIG. 11 is a diagram showing an example of a flow of data in the question response processing according to the present embodiment. In the question response processing of the present embodiment, in the processing of step S204, the second query generation unit 112B generates the second query used for searching a second information source 400 using both the question acquired in the processing of step S201 and the first search result acquired in the processing of step S203. For example, the second query generation unit 112B inquires the large language model about the keyword related to both the question and the first search result and acquires the keyword output by the large language model as the second query. Thereafter, a second search unit 113B executes the search of the second information source 400 using the second query to acquire the information related to both the question and the first search result as the second search result (step S205).

According to a question response apparatus 100 of the present embodiment, by generating the second query using the question in addition to the search result of the first information source 300 with high reliability, it is possible to generate the second query with high reliability and strongly related to the question. Then, by searching the second information source 400 using the second query, it is possible to search the information with high reliability and strongly related to the question from the second information source 400. In addition, by generating an answer to the question by using the integration prompt generated by using a highly reliable search result, it is possible to further improve the answer quality.

Note that, also in the present embodiment, similarly to the first embodiment and the modification, it may be determined that the combination of the search results having the maximum consistency score is consistent, only search results from the information source having high reliability may be used in a case where no combination of the search results having a high similarity score is found, the consistency of search results may be determined in consideration of subsidiarity of the search results, or the search results acquired from three or more information sources may be combined.

Thus, according to any of the embodiments described above, it is possible to provide a question response apparatus, a method, and a program with improved answer accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A question response apparatus comprising processing circuitry configured to:
acquire a question input by a user;
generate a query based on the question;
search a search result related to the query from a plurality of information sources;
determine consistency of the search result;
generate an integration prompt in which a search result determined to be consistent and the question are integrated; and
generate an answer to the question by inputting the integration prompt into a large language model.

2. The question response apparatus according to claim 1, wherein
the information sources includes a first information source and a second information source,
the processing circuitry is configured to:
generate a first query based on the question and a second query generation unit that generates a second query based on the question;
search the first information source for a first search result related to the first query;
search the second information source for a second search result related to the second query;
determine consistency between the first search result and the second search result; and
generate an integration prompt in which the question and a first search result and a second search result that are determined to have consistency are integrated.

3. The question response apparatus according to claim 2, wherein
the first information source is more reliable than the second information source, and
the second information source has higher searchability than the first information source.

4. The question response apparatus according to claim 2, wherein
the processing circuitry is configured to generate the second query based on the first search result.

5. The question response apparatus according to claim 2, wherein
the processing circuitry is configured to generate the second query based on the question and the first search result.

6. The question response apparatus according to claim 1, wherein
the query is a keyword extracted from the question, and
the processing circuitry is configured to search the information source for information including the keyword.

7. The question response apparatus according to claim 6, wherein
the processing circuitry is configured to extract the keyword by inquiring a large language model about the keyword in the question.

8. The question response apparatus according to claim 1, wherein
the query is an embedded expression of the question, and
the processing circuitry is configured to search the information source for information similar to the embedded expression of the question.

9. The question response apparatus according to claim 1, wherein
the processing circuitry is configured to determine consistency of the search result by inquiring a large language model whether the search result has consistency.

10. The question response apparatus according to claim 1, wherein
the processing circuitry is configured to determine consistency of the search result based on similarity of the search result.

11. The question response apparatus according to claim 1, wherein
the processing circuitry is configured to repeatedly execute generation of the query by the query generation unit and search by the search unit until it is determined that the search result has consistency.

12. The question response apparatus according to claim 1, wherein
the processing circuitry is configured to determine that a combination of a search result having a maximum consistency score has consistency.

13. The question response apparatus according to claim 3, wherein
the processing circuitry is configured to generate an integration prompt in which the question and the first search result are integrated in a case where it is determined that the first search result and the second search result do not have consistency.

14. The question response apparatus according to claim 1, wherein
the processing circuitry is configured to determine that a combination of a search result having a high consistency score or a combination of a search result having high subsidiarity has consistency.

15. A method comprising:
acquiring a question input by a user;
generating a query based on the question;
searching a search result related to the query from a plurality of information sources;
determining consistency of the search result;
generating an integration prompt in which a search result determined to have consistency and the question are integrated; and
generating an answer to the question by inputting the integration prompt into a large language model.

16. A non-transitory computer-readable storage medium storing a program for causing a computer to execute functions of:
acquiring a question input from a user;
generating a query based on the question;
searching a search result related to the query from a plurality of information sources;
determining consistency of the search result;
generating an integration prompt in which a search result determined to have consistency and the question are integrated; and
generating an answer to the question by inputting the integration prompt into a large language model.
